(19) United States
(12) Patent Application Publication
(10) Pub. No.: US 2008/0310619 A1
(43) Pub. Date: Dec. 18, 2008

(54) Process of Encryption and Operational Control of Tagged Data Elements

(76) Inventors: Edward M. Scheidt, McLean, VA (US); James L. Kolouch, Vienna, VA (US)

Correspondence Address: IP STRATEGIES, 12 1/2 WALL STREET, SUITE E, ASHEVILLE, NC, 28801, US

(21) Appl. No.: 11/912,404

(22) PCT Filed: Apr. 25, 2006
(86) PCT No.: PCT/US2005/014282

§ 371 Date: Aug. 8, 2008

(51) Int. Cl. H04L 9/28

(52) U.S. Cl. 380/28

(57) ABSTRACT

A process of encrypting an object having an associated object tag includes generating a cryptographic key by binding an organization split, a maintenance split, a random split, and at least one label split (710). A cryptographic algorithm is initialized with the cryptographic key, and the object is encrypted using the cryptographic algorithm (712) according to the object tag, to form an encrypted object. Combiner data is added to the encrypted object (711). The combiner data includes reference data, name data, a maintenance split or a maintenance level, and the random split (710). Alternatively, key splits are bound to generate a cryptographic key, and a cryptographic algorithm is initialized with the cryptographic key. The initialized cryptographic algorithm is applied to the object according to a cryptographic scheme determined by the object tag, to form an encrypted object. One of the key splits corresponds to a biometric measurement.

### TECHNICAL FIELD

The present invention is directed to methods of safeguarding data and restricting physical or electronic access to information and operations.

### BACKGROUND ART

Keys are an essential part of encryption schemes. Their management is a critical element of any cryptographic-based security. The true effectiveness of key management is the ability to have keys created, distributed, and maintained without requiring user interaction and without penalizing system performance or costs.

Asymmetric, also called public-key, cryptography has received significant attention in recent years. The public-key method includes separate public encryption and private decryption keys that provide a measure of difficulty in deriving the private key from the public key. Public-key management was developed to establish cryptographic connectivity between two points in a communications channel after which a symmetric cryptogen, such as DES (Data Encryption Standard), was to be executed. Over the years public-key implementations have demonstrated their effectiveness to authenticate between entities. However, public-key methods have not been able to successfully handle the requirements of today's global networks.

Many of the recent public-key implementations allow users to create their own keys. This can leave an organization vulnerable, and in some cases liable, if users leave and fail to identify their private keys. Also, to ensure the integrity of public keys, third party infrastructure designs have been proposed. A Certificate Authority process confirms that a certain public key was issued to a specific user. The exchange of certificates with a third party can significantly impact the performance of a network.

The public-key process is also associated with high computation times. In many instances, hardware solutions have compensated for these high computational requirements. Since public-key architectures have been historically point-to-point designs, moving to a distributed network with group sharing of information can create higher transmission costs and greater network impact. While public-key management systems work well for point-to-point communications and one-to-one information transfer, they are too time-consuming for a single file placed on a server and decrypted by thousands of users. As the trend toward work groups and complex communications infrastructures continues, the need for a more efficient information and communications key management technology becomes paramount.

Shared secret keys used with symmetric key cryptosystems is the earliest key management design and pre-dates public-key management. Early symmetric key designs suffered from the “n-squared” problem since the number of keys required becomes very large and unmanageable as the number of users increase. In addition, these designs did not have effective authentication. Symmetric encryption does have significantly better processing performance than public-key implementations.

Generally, cryptographic systems are used to prevent unauthorized disclosure of information during transmission and/or storage of data. The process of encryption involves the manipulation of data so that it is unreadable, in effect making the content inaccessible, to an unauthorized entity. The process of decryption involves the manipulation of encrypted data so as to recreate the original scheduled condition of the data, or to transform the encrypted data into readable data that corresponds to the original unencrypted data. Secrecy is not the only advantage provided by encryption. The process of encryption ensures data integrity, as encrypted data that has been modified does not decrypt properly unless the proper, that is, authorized, procedures are followed.

The corporate world used to depend solely on paper to operate. Hard copy documents were used to provide corporate governance, settle disputes at law, and formed the basis for audits by tax and regulatory authorities, internal authorized recipients, and independent accountants. In many instances, this is no longer the case. As business moves to electronic operational and accounting systems, hard copy documents in many cases either do not exist or are merely incidental to electronic records. This lack of hard copy affects the ability of management and other interested parties to manage and audit corporate systems.

An original paper document carries a degree of presumption of authenticity that cannot currently be attributed to an electronic file. Changes can be virtually impossible to detect in the electronic world. With electronic data interchange, a company uses computers, computer programs, and transmission links to automatically transact business with customers and suppliers. With image processing systems, documents are scanned and converted to digital images. The original documents might not be retained. Some electronic information may exist for only a short time and may not be retrievable if files are updated and backup files do not exist.

Some companies have many information and control systems. In this context, a system is the entire combination, or a logical sub-part, of tangible and intangible elements that, acting together, protect assets and provide reliable data, or the assurance thereof. The tangible part of the system includes, but is not limited to, paper documents and the markings and signatures made thereon, as well as the physical processes and procedures used to safeguard assets. System intangibles include policies and procedures providing instructions and structure to the business process.

Management and other interested parties must determine that policies, procedures, and instructions are carried out to a sufficient degree in a timely fashion. Information and control systems provide this assurance. Authorized recipients review information and control systems to determine if the design of each meets stated objectives. They also review the synergistic effect of all relevant systems to determine their overall effectiveness. If the sum of all system designs is deemed to be effective in producing stated objectives, authorized recipients then must perform tests of these systems in order to prove the systems actually exist and are functioning as represented by management.

Based on the volume of information involved, authorized recipients and others reviewing corporate activities cannot directly examine all activities and data produced by a company. They must devise tests for evaluating the activities and data that they can directly examine, in order to provide a reliable indication of the overall well-being of the corporation. The nature, timing, and extent of these tests are based on professional judgment. Tests include those steps necessary to verify that stated control elements exist and are functioning as intended. Tests also include the examination of particular transactions to provide operational assurance on a statistical basis.

The tests of both controls and transactions can include the examination of documents produced both within the company and by outside entities. For some audit objectives, such as confirmation of balances, is activities, agreements, etc., evidence will be obtained from parties independent of the company. The authorized recipient's goal is to reduce to an acceptable level the risk of not discovering a material misstatement or system control deficiency. If an authorized recipient cannot reduce detection risk to an acceptable level, it may be impossible to render an unqualified opinion.

As more businesses adopt electronic systems and interact electronically with vendors and customers, the ability to reliably audit both controls and transactions is greatly diminished, perhaps, in some cases, to the point that serious adverse control and audit consequences will become common.

### DISCLOSURE OF INVENTION

The process of the present invention builds on the advantages, and takes into account the disadvantages, of both public-key and symmetric key implementations. This process combines an encryption process based on split-key capability with access control credentials and an authentication process based on public-key techniques. The process is most effective in modern distributive information models where information flow and control can be defined, where the information encrypted might need to be recovered, and where authentication using public-key technology and a physical token can be implemented.

This process emphasizes the encryption of data-at-rest as opposed to data-in-transit. Data-at-rest refers to data encrypted as logical units (objects) and includes the creation, processing, transfer, and storage of these objects. Data-in-transit refers to the stream encryption of data moving through a physical or logical communication channel during a certain period of time. The process of the present invention can perform both types of encryption, but for ease of explanation, data-at-rest capability will be emphasized.

The present invention utilizes a cryptographic key management system that uses pre-positioned key splits to build cryptographic keys when needed. The architecture provides a complete cryptosystem for today's large distributed networks. The key management system of the present invention meets the set of “classical” security objectives, as described below.

Data confidentiality keeps the content of information from being revealed to those who are not authorized to read it. The present invention uses symmetric key cryptography with a robust key management system that provides a new and unique working key for each encryption. The user “selects” the readership or has the readership defined for each encrypted object. An object can be data-at-rest, such as a file, a message, or data-in-transit, such as network traffic.

Access control restricts use of encrypted objects to those users specifically given permission to use them. Access control according to the present invention can be role-based, for which permissions are granted and revoked based on that user's responsibility or position within an organization. It currently encompasses the actions of encryption and decryption but may is include permissions to use certain programs, certain devices or specific hardware operating modes. Access control can also be extended to database applications.

User authentication establishes the identity of a user (person or device) to the system. User authentication becomes stronger when other enhancements, discussed below are added to the system and process of the present invention.

Smart cards and biometrics provide the present invention with greater security in meeting the objective of user authentication. As well as providing stronger user authentication when used as a token, a smart card can be an excellent hardware platform to implement various levels of the key management technology. The card may be used as a memory-only device, or it can be expanded to include processing capability. An advanced smart card, called the SuperCard™ is an enabling technology for the present invention. Along with its increased processing and memory, the SuperCard™ includes a unique radio frequency signature and random number generation capability. Such a card is described, for example, in U.S. Pat. No. 6,229,445.

Adding biometrics to the process enhances user authentication and can provide pieces of information for generating the private key part for the asymmetric key cryptographic system that the system uses for digital signatures.

Inherent in described process is the means to meet additional objectives. For example, data separation is the ability to keep data in the same physical space yet still enforce access controls. Two cryptographic means of separation are used by the present invention—separation by algorithm and separation by label. Key recovery is the ability to regenerate the keys used to encrypt objects. Key recovery means that within any particular domain (or organization) encrypted objects are not lost with the loss of any individual. Key recovery for export is also possible.

Asymmetric key cryptography used for digital signatures according to the present invention offers the means to meet additional security objectives concerned with message authentication. Data origin authentication (sometimes called message authentication) corroborates the source of information encrypted by the process of the present invention. Data integrity is the ability to prove that an encrypted object has not been altered since being encrypted and digitally signed. If digital signatures are not used a Message Authentication Code (MAC) or Manipulation Detection Code (MDC) with encryption can provide data integrity. Non-repudiation proves that the signature on a signed object came from the signatory such that the signatory cannot deny having digitally signed the object.

Thus, encryption and encrypted objects can be used to record and authenticate inputs, processes, scheduled conditions, and virtual environments of electronic accounting and operational systems, and to provide a means to distribute these encrypted objects to designated locations for access by designated individuals or entities.

Inputs in this context can be any individual action or sum of actions having any effect on a control or accounting system. Outputs in this context can be the result of any process or action of a control or accounting system. These actions can be transactional in nature, directly entered by a human being as the first electronically recorded action, or can be a result of computations within the system, or can be passed to the system by another system.

According to an aspect of the invention, a process of encrypting an object that is consistent with a data format and has an associated object tag therewith includes binding a number of key splits to generate a cryptographic key. A cryptographic algorithm is initialized with the cryptographic key. The initialized cryptographic algorithm is applied to at least a portion of the object according to at least one cryptographic scheme determined at least in part by the object tag, to form an encrypted object. At least one of the number of key splits corresponds at least in part to a biometric measurement.

The encrypted object can be stored for subsequent use by an intended recipient.

The object can be selected from a plurality of objects, at least in part according to the associated object tag.

The object can be, for example, an Extensible Markup Language element.

At least one key split of the plurality of key splits can be added to the encrypted object. Likewise, reference data associated with at least one key split of the plurality of key splits can be added to the encrypted object.

At least one key split of the plurality of key splits can be retrieved from a storage medium. For example, the storage medium can be disposed on a smart card. Likewise, the action of binding a plurality of key splits to generate a cryptographic key can be performed on a smart card.

According to another aspect of the invention, in a cryptographic system associated with an organization, a process of encrypting an object that is consistent with a data format and has an object tag associated therewith includes generating a cryptographic key by binding an organization split corresponding to the organization, a maintenance split, a random split, and at least one label split. A cryptographic algorithm is initialized with the cryptographic key. At least a portion of the object is encrypted according to the initialized cryptographic algorithm, determined at least in part by the object tag, to form an encrypted object. Combiner data is added to the encrypted object. The combiner data includes reference data corresponding to at least one of the at least one label split and the cryptographic algorithm, name data associated with the organization, at least one of the maintenance split and a maintenance level associated with the maintenance split, and the random split. The encrypted object can be stored with the added combiner data for subsequent use by an intended recipient.

The object can be selected from a plurality of objects, at least in part according to the associated object tag.

The object can be, for example, an Extensible Markup Language element.

The at least one label split can be selected from at least one credential. In this case, the selected at least one label split can be encrypted, the cryptographic key can be a first cryptographic key, and the process can also include deriving a second cryptographic key from a user ID associated with a user, a password associated with the user, and at least one of a unique data instance and a random value. The selected at least one label split can be decrypted using the second cryptographic key. At least one credential can be retrieved from a memory. For example, the memory can be disposed on a smart card. A time stamp can be generated that corresponds to a time at which the object was encrypted, and the combiner data can also include the time stamp. The combiner data can also include a user ID associated with a user.

The combiner data can be a header record.

The combiner data can also include a digital signature or a digital certificate, or both.

The cryptographic key can be a first cryptographic key, and the process can also include generating a second cryptographic key based at least in part on the at least one label split. The random split can be encrypted using the second cryptographic key, prior to adding the combiner data to the encrypted object. The random split included in the combiner data can be the encrypted random split.

At least a portion of the combiner data can be encrypted using a header split before adding the combiner data to the encrypted object. The header split can be constant.

According to another aspect of the invention, a storage medium includes instructions for causing a data processor to encrypt an object that is consistent with a data format and has an associated object tag. The instructions include generate a cryptographic key by binding a number of key splits, initialize a cryptographic algorithm with the cryptographic key, and apply the initialized cryptographic algorithm to at least a portion of the object according to at least one cryptographic scheme determined at least in part by the object tag, to form an encrypted object. At least one of the number of key splits corresponds at least in part to a biometric measurement.

The instructions can also include select the object from a plurality of objects, at least in part according to the associated object tag.

The object can be an Extensible Markup Language element.

The instructions can also include add at least one key split of the number of key splits to the encrypted object.

The instructions can also include add reference data associated with at least one key split of the number of key splits to the encrypted object.

The instructions can also include retrieve at least one key split of the plurality of key splits from a memory. For example, at least a portion of the memory can be disposed on a smart card.

The data processor can be distributed, and the instruction to generate a cryptographic key can be executed at least in part on a smart card.

According to another aspect of the invention, a storage medium includes instructions for causing a data processor to encrypt an object that is consistent with a data format and has an associated object tag. The instructions include generate a cryptographic key by combining an organization split corresponding to an organization, a maintenance split, a random split, and at least one label split, initialize a cryptographic algorithm using the cryptographic key, apply the initialized cryptographic algorithm to at least a portion of the object according to the initialized cryptographic algorithm determined at least in part by the object tag, to form an encrypted object, add combiner data to the encrypted object, and store the encrypted object with the combiner data for subsequent access. The combiner data includes reference data corresponding to at least one of the at least one label split and the cryptographic algorithm, name data associated with the organization, the maintenance split and/or a maintenance level corresponding to the maintenance split, and the random split.

The instructions can also include select the object from a plurality of objects, at least in part according to the associated object tag.

The object can be an Extensible Markup Language element.

The instructions can also include select the at least one label split from at least one credential. In this case, the selected at least one label split can be encrypted, the cryptographic key can be a first cryptographic key, and the instructions can also include derive a second cryptographic key from a user ID associated with a user, a password associated with the user, and at least one of a unique data instance and a random value, and decrypt the selected at least one label split using the second cryptographic key. The instructions can also include retrieve at least one credential from a memory. For example, the memory can be disposed on a smart card. The instructions can also include generate a time stamp corresponding to a time at which the object was encrypted, and the combiner data can also include the time stamp. The combiner data can also include a user ID associated with the user.

The combiner data can also be a header record.

The combiner data can also include a digital signature or a digital certificate, or both.

The cryptographic key can be a first cryptographic key, and the instructions can also include generate a second cryptographic key based at least in part on the at least one label split, and encrypt the random split using the second cryptographic key, prior to executing the instruction to add the combiner data to the encrypted object. The random split included in the combiner data can be the encrypted random split.

The instructions can also include encrypt at least a portion of the combiner data using a header split prior to executing the instruction to add the combiner data to the encrypted object. The header split can be constant.

### BRIEF DESCRIPTION OF DRAWINGS

FIG. 1 is a block diagram illustrating an exemplary process of the invention.

FIG. 2 is a block diagram illustrating an exemplary process of the invention.

FIG. 3 is a flow diagram of a system using encryption as a tool for checking the integrity of a process.

FIG. 4 is a flow diagram showing encryption used in an output context.

FIG. 5 shows a process by which selected process elements provided as inputs to the process are manipulated.

FIG. 6 shows how scheduled conditions can be sampled in a system.

FIG. 7 shows virtual environmental data collected and embedded within an encrypted object.

FIG. 8 is a flow diagram showing use of XML to identify, copy, and encrypt input objects in a SAOCRS.

FIG. 9 is a flow diagram showing use of XML to identify, copy, and encrypt copied output objects in a SAOCRS.

FIG. 10 is a flow diagram showing use of XML to identify, copy, and encrypt copied objects in a SAOCRS that in their entirety present a scheduled condition check.

### BEST MODES FOR CARRYING OUT THE INVENTION

The basic design focuses on the functions needed for encryption and decryption of objects and the distribution of keys. High performance symmetric key cryptographic algorithms and a patented method of key management are used at this level. Another level, focusing on authentication, uses smart cards and biometrics to create strong entity authentication and uses digital signatures for message authentication. A third level that adds a mix of detection techniques for internally protecting the authentication and encryption processes is added when the environment requires more security.

### Technology Overview

The present invention provides technology for generating and regenerating cryptographic keys, and managing those keys within an organization. A cryptographic working key is generated immediately before an object is encrypted or decrypted. It is used to initialize a cryptographic algorithm for encryption or decryption. The working key is discarded after use.

The working key is built from many pieces of information. To be a participant in the system, a user must have the pieces necessary to build the key; otherwise encryption and decryption cannot take place. A central authority generates these pieces, which are called cryptographic key splits. A subset of these splits is distributed to each user in the organization. The subset that each user receives is specific to that person and defines which labels that individual may use to encrypt (known as write permission) and which labels that individual may use to decrypt (known as read permission). Several user authentication techniques are used to verify a user to the system before that user is allowed access to this information.

To build a key, a constant system wide-split, called the organization split, and a variable system wide split, called the maintenance split, are used. To this are added a random number, which is called the random split, and user-selected label splits. The random split ensures that a unique working key is created for each use. User selected label splits define the “readership” of the encrypted object, that is, which users will be able to decrypt the object. All of these splits are input to a process known as the combiner process. The output of the combiner process is a unique number that is used as the basis for the session key.

The present invention uses a hierarchical infrastructure to manage the distribution of information necessary for software to construct cryptographic keys. This infrastructure also provides a method of user certificate and public key distribution for asymmetric key cryptography so that digital signatures can be used.

### Infrastructure

The present invention is preferably structured as a three-tiered hierarchical system. The top tier is a process identified as the Policy Manager. This process enables the “central authority” for the encryption domain to generate splits, for example, 512 random bits, to be used in key generation. Splits are labeled and are used in combination by users to generate cryptographic keys.

The next tier in the hierarchy is a process identified as the Credential Manager. This process is given a subset of labels and specific algorithms and policies from the Policy Manager. Individuals are allocated use of specific labels and algorithms from the Credential Manager's subset. Organizational policies and system parameters generated by the Policy Manager are added to these labels, forming an individual's credentials. A user's credentials are encrypted and distributed to that user on a “token”, such as a diskette or a smart card, or installed on a workstation or server. The process of label and algorithm allocation by the Credential Manager allows an organization to implement a “role-based” system of access to information.

As a convenience to the Credential Managers, password Supervisors can securely distribute “first use” passwords to users that will unlock user credentials the first time they are used.

Access to user credentials is controlled at the user tier of the hierarchy with a password that is initially assigned by the Credential Manager. The password is changed at the time of first use by the user and is known only to the user. This provides rudimentary user authentication. Stronger authentication is provided by enhancements to the system.

User authentication enhancements include a smart card—a processor and memory packaged into a plastic card or other token, like a credit card—that can hold pieces of information for user authentication. It can also retain information for use by the system and provide processing for the system. A smart card with tamper resistance and hardware random number generation capability offers additional security.

Another authentication enhancement is the use of biometric data. Biometric data is physiological or behavioral information that is unique to each individual and that does not change during that individual's lifetime. Furthermore, it has to be something that can be digitized and used by a computer. In addition to strong user authentication, biometric data may be used in the creation of private keys for digital signatures.

For data integrity alone, a Message Authentication Code (MAC) can be used. Instead of the system-generated key being used to initialize symmetric key algorithms, a generated key is used to initialize a MAC. Manipulation Detection Codes (MDCs) can also be used to provide data integrity and secrecy when combined with encryption according to the present invention.

If data origin authentication, data integrity, and non-repudiation are required, then the system infrastructure is used to provide the means to distribute public keys which give the present invention the ability to use cryptographic-bound digital signatures. If a digital signature is used, MACs or MDCs are not required. Combining digital signatures with the basic design and adding user authentication enhancements establishes the means to meet the security objectives stated above.

### Combiner Function and Splits

The combiner is a non-linear function that receives multiple inputs and produces a single integer. The integer output is used as the session key for encrypting and decrypting objects.

The starting point for the combiner function is the organization split. Everyone in the organization has access to this split. It is equivalent to what is usually called the system key.

During encryption, a user will choose one or more label splits to be used in the combiner process. This will define the authorized readership of the encrypted object, as only those who have read access to splits used for encryption will be able to decrypt the object. The selection and usage of an organization's labels by users should be taken into account in designing the label set. Good label set design should mirror an organization's established information compartments. Access to labels that can be provided to a user by a Credential Manager based on the role of that user within the organization.

It is also possible, at either the Credential Manager or Policy Manager level, to specify mandatory use labels for a specific user or group of users. These correspond to label splits that are always used when the user encrypts an object. The user has no choice in their selection—they are used automatically in the combiner.

A random split, generated for each encryption, is another split that is provided as an input to the combiner function to make the final working key. Because a new random split is generated at each encryption, the working key is always changing. It will not be the same even if the same object is encrypted again using the same labels. The random number preferably is provided by a hardware-based random number generator. However, if hardware is not available or practical, a software-based pseudo-random number generator can be used.

The maintenance split is used for key updating and compromise scenarios. The organization's policy may require that one of the splits be periodically changed. The maintenance split is changed in order to make an organization-wide impact. The Policy Manager can periodically generate a new maintenance split that is distributed to users via credentials file updates. Generation of the maintenance split is done in such a manner that all the previous maintenance splits can be recovered. Thus, for data-at-rest architectures, previously encrypted data can be recovered. For data-in-transit architectures, such as encrypted network traffic, there is no need to recover previous maintenance splits.

The maintenance split can be used to exclude someone from the organization domain. If an individual does not have credentials that have been updated with the new maintenance split, then that individual will not be able to decrypt objects that have been encrypted using this new maintenance split. Updating the maintenance split will also protect encrypted data if a user's credentials have been compromised.

In summary, the organization split is a constant number used in all encryption. The maintenance split is used to maintain a periodic chance to the working key's input. The user selects label splits, and the random split is always unique, thus ensuring that every encrypted object has a different key.

### Cryptographic Algorithms

The present invention, with its pre-positioned splits in user credentials, provides key management for symmetric key cryptographic algorithms. The impact of the classical n-squared key management problem has been lessened without resort to asymmetric or “public-key” cryptographic systems. However, the infrastructure provided for the private key management solution can also be used for public-key management. Asymmetric key cryptosystems are used by the present invention for message authentication and can be used for user credential distribution and for key exchange for the communications protocol between workstation and smartcard.

Preferably, a minimum of two symmetrical key algorithms are provided for use with the present invention—for example, P², (a stream cipher algorithm) and the U.S. Data Encryption Standard (DES) algorithm, a block cipher algorithm. Other algorithms are available subject to business considerations, such as United States export regulations and license agreements.

For the DES block algorithm, four different operating modes are provided—Electronic Code Book (ECB), Cipher Block Chaining (CBC), Output Feedback (OFB) and Cipher Feedback (CFB). In addition, CFB is offered in 1-bit, 8-bit, or n-bit feedback where n is the block size (or integral division of block size). Output feedback is also available in counter mode.

Triple encryption is also available for every block algorithm, subject to export regulations. This means that not only triple DES is available but also, for example, triple IDEA, triple RC5, etc. can be used. As with all block algorithms, the four stated operating modes are available. There are additional operating modes available with triple encryption and decryption.

The Policy Manager may rename an algorithm and operating mode. Different algorithms can be put to use for different purposes and an algorithm's name may reflect its use. The names of the algorithms that a user has permission to use are contained in the user's credentials. Since the Policy and Credential Managers control access to algorithms, applying different algorithms has the effect of further compartmenting access to encrypted data.

Symmetric key algorithms are used by the present invention for encrypting objects. They are also used internally by processes of the present invention, such as in the combiner. Asymmetric key cryptographic systems may also be used by the present invention for message authentication, credential distribution, and the key exchange protocol between smart card and workstation.

A biometric reading can provide the basis for a user's private key used for message authentication. In this case, the private key need not be stored since the user can recover it by taking the biometric reading. The public key used for authentication is usually derived from this private key and is stored in the user's Credential Manager's database. To base the private key on a biometric reading requires special properties regarding the biometric. Normally, these special properties do not apply, in which case the private key will need to be generated by the user and stored, usually on a user's workstation or smartcard. A secure backup is needed for this private key in case of loss. Note that the Credential Manager preferably will not have access to a user's private key used for authentication.

The public-key pair for each user that is used for credential distribution is generated and stored by the Credential Manager. Since these key pairs are used only to encrypt information from the Credential Manager to the user, the private key does not have to remain unknown to the Credential Manager. Thus, the Credential Manager stores both the public and the private keys for its users in its database. User's public keys are used to encrypt the key used to encrypt user credentials for distribution. The Credentials Manager stores user's private keys only for backup purposes. Users must have their own copy of their private key so they can decrypt their credentials when received.

Asymmetric key systems are also used for exchanging a session key between a system-enabled smart card and a workstation. On installation of system software, a public and private key pair is generated by the workstation and by the smart card for this purpose. A station-to-station protocol, for example ISO9798-3 using mutual authentication with random numbers, is used to exchange a session key that is used to encrypt the communications between the smart card and the workstation.

### User Credentials

User credentials, contained in computer files, include a user's permission set, that is, the label splits, their associated label names and indices that can be used for encryption (write permission) and decryption (read permission), and the permissions to algorithms that may be used. In addition, the organization name and associated split, maintenance level and associated split, header encryption split, and certain parameters to be used by the organization are contained in a user's credentials. Policies, such as minimum password length, are also included in the user's credentials. When digital signatures are used, a copy of all the organization's Credential Manager's public keys are included, as well as the user's signed certificate.

In assigning a permission set to a user, the Credential Manager looks to that user's role and its related responsibilities and privileges within the organization. Role templates and role hierarchies in the Credential Manager software aid the Credential Manager in this job. An individual's role may change; hence, credentials can be reissued with different labels, or can even be revoked altogether for an individual who has left the organization.

User credentials are encrypted and must be decrypted by each user before use. Decrypting the credential file is the basis for cryptographically identifying the user. The key used for encryption and decryption is derived from the user's ID, as is a password that only the user knows. Some unique data, such as a date/time stamp associated with the file, or a random number residing in a place different from that of the credentials file is also used. Every time the credentials file is decrypted for use, it is re-encrypted using different data. Since this data is always changing, the credentials file is encrypted with a different key after every use. This increases the work that an adversary must perform to break a user's credentials. Since a piece of information other than a password is used, an adversary must determine this unique data before a password-guessing attack can take place.

When a smart card is used, a random number can be stored on the smart card. This has the effect of tying the user and the smart card to the credentials file. In this case the credentials file cannot be decrypted without the smart card.

When biometrics is used, the biometric reading offers another piece of information from which to derive the credentials file encryption key if the reading can be reproduced exactly each time. This further ties the user to the credentials file. However, if the biometric reading cannot be reproduced exactly each time, it must be compared to a stored baseline template for variance calculation purposes. In this case, the template is not used in the encryption of the credentials. Instead, it is used for authentication and is carried in the credentials where it is used to compare to each biometric reading.

The credentials file carries an expiration date. Beyond this date the credentials file is useless. Each encrypted object contains a time stamp in its header. Objects encrypted by others beyond the expiration date of the credentials cannot be decrypted. The maximum time-out value, that is, the time from credentials issuance to credential expiration, is set by the Policy Manager. A Credential Manager may further restrict the time-out but cannot extend the time-out value when issuing credentials to a user. To use the system of the present invention after credentials have expired, a user must have credentials reissued by that user's Credential Manager.

On issuance or re-issuance of a credentials file, the Credential Manager software generates a new “first-use” password. Before the new credentials can be used for the first time, the “first-use” password must be used to decrypt the credentials and then a new password must be provided for subsequent encryption and decryption of credentials.

The “first-use” password is generally transmitted to the user using a different communication channel than that used to transmit the credentials file. An asymmetric key cryptographic algorithm may be used to encrypt a “first-use” key. A private key provided by the Credential Manager is used to recover this “first-use” key and decrypt the credentials.

When biometrics is used in the encryption of the credentials file, the user's public key is contained in the credentials and will be used as a check. Only the correct biometric reading will produce a private key that generates a public key that matches the one in the credentials.

To be able to encrypt, decrypt, sign, and verify objects, a user must have credentials. They provide most of the “secret” information needed for these actions and are tied to a user with strong authentication techniques when the full system is used. A user's access permissions may be revoked by taking away that user's credentials or by allowing them to expire without renewal. If credentials are required to be stored on a server, then a user's credentials may be removed immediately. Once the Policy Manager issues a new maintenance split, user credentials that have not been updated are useless for any data encrypted after this update—a further means to force a user off the system.

### The Header

Every encrypted object contains added information, preferably in a header. This information is needed to decrypt the object. It contains, as a is minimum, an index to the label splits and the algorithm used in the encryption process, the organization name, the maintenance level pointing to the maintenance split to be used, and the random split. The random split is encrypted by using an encryption key based on the same label splits used to encrypt the object. To be able to recover the random split, a user must have read access to the label splits that were used in encrypting the object. The organization split, maintenance split, and label splits that are contained in a user's credentials, along with the random split recovered from the header, allow the encryption key to be recovered. The object may then be decrypted.

Also contained in the header is a time stamp indicating the date and time the object was encrypted. The present invention will not allow a user with credentials that have expired before this date to decrypt the object.

The ID of the user who encrypted the object, as well as the identity of that user's Credential Manager, is contained in the header. If a digital signature is used, it is contained in the header along with the user's certificate. With the appropriate Credential Manager's public key, all of which are contained in each user's credentials, the certificate can be decrypted to recover the signing individual's public key. This public key is used to verify the digital signature once the message is decrypted.

Most of the header itself is encrypted using a constant header split. The intent of using this split is not security. This is a step to discourage anyone from trying to break the system by preventing easy initial success. All information in the header is either public, or in the case of the random split, encrypted within the header.

Data contained in the header can offer a basis for certain types of information searches and database queries. Search engines could contain logic to look at the header to provide data separation. Since decrypting the header does not reveal message contents, a process may be placed on network monitoring and control devices to check traffic for verification, integrity, routing, etc. without revealing the encrypted data. For example, label information contained in the header can be the basis for keeping encrypted data confined to a network by having routers prevent data with particular labels from crossing certain network boundaries. Thus, by using the header, the present invention lends itself to managing and encrypting data-in-transit over a network, as well as static data-at-rest.

### Data Separation

Data separation is the process of assigning data to and restricting access to each category based on need-to-know. One way of accomplishing this is by physically placing data where unauthorized people cannot access it. However, providing physically separate networks or machines to host different sets of data is costly. The present invention provides a way of separating data so those with authority will have access to it without having to physically keep the data confined to different networks, hard disk drives, servers, etc.

### Key Recovery

Key recovery is an organized process to regenerate the encryption key requiring several deliberate events, plus access to the encrypted object. The Policy Manager can initiate this process and provide any Credential Manager with all label splits required. The Credential Manager is able to provide credentials with read capability for label splits that were used to encrypt the object.

Note that an expiration date is set for credentials files. It is possible for the Credential Manager to create a credentials file that is valid for only one day. For example, pursuant to a judicial order, law enforcement may be issued read-only splits to recover information they need. They would not be able to recover information encrypted subsequently.

Another reason to use key recovery would be for recovering data encrypted by an employee that has left the organization, died, or who has become incapacitated. The loss of an individual does not mean that data encrypted by that individual cannot be recovered.

If a user's original credentials are lost or the password is forgotten, the present invention can recreate a user's credentials. This is accomplished by simply issuing new credentials to the user. The user chooses a new password upon initial use of the new credentials. In some cases it is possible to regenerate the original private and public keys assigned to a user for authentication.

### User Authentication Enhancements

Strong user authentication requires something that an individual knows, something possessed by the individual, and something that individual is. Passwords, something known, are used for rudimentary user authentication. Smart cards (or other tokens) are something possessed. Biometric data is something an individual is. Any combination of all three may be used in the system of the present invention.

### Smart Cards

Smart cards may be used to hold key pieces of information according to the process of the present invention. A random number stored on the card can be used as a piece of information in building the key to encrypt each user's credentials. This ties the smart card to the credentials. Without the number stored on the card, decryption of a user's credentials is not possible. The user needs the card to complete session establishment before the system can be used. Other pieces, such as a password, are still needed to log on to the system. The smart card alone is not sufficient to start a session, thus defeating an adversary who has stolen or otherwise acquired a user's smart card.

User credentials can be stored on the smart card. This would let the user travel to other machines that are not part of the organization's main network and still be able to use the system.

Security is enhanced by keeping decrypted user credentials in the smart card's memory only for the duration of a session, as well as by running the combiner process on the smart card's processor. Local processing within the card increases the workload of an adversary who is attempting to view the internal workings of processes in order to gain information about secret keys.

### The SuperCard™

The SuperCard™ is an ISO-compliant smart card that has enhanced processing ability and greater memory than current smart cards. It includes tamper resistance and hardware random number generation. The processing capability internal to the card can be used to reduce task processing on the workstation. Even though the bandwidth between the card and the workstation is limited, with the system of the present invention only small amounts of data are transferred between the two. Larger memory within the card also makes it possible to store user credential files, as well as “private” applications.

To keep “secret” information, such as splits, from being revealed to someone monitoring communications between the card and the workstation, the communications between the SuperCard™ and the workstation are encrypted. The key agreement protocol used to exchange the encryption key is between the card and the workstation. No additional intelligence is required in the card reader.

An inherently random radio frequency signature, called Resonant Signature-Radio Frequency Identification (RS-RFID), which is provided by tangents embedded within the card, aids tamper resistance. The digital representation of the RS-RFID of the card is contained within a user's credentials file and is encrypted with the credentials. Any tampering with the card will change the RS-RFID of that card. When the damaged RS-RFID is used, the wrong radio signature is read and will not compare to the decrypted value of the RS-RFID from the user's credentials file. Thus, tampering with the card will be detected. The card reader that reads the SuperCard™ contains hardware to read the RS-RFID signature. In addition, the SuperCard™ can be used in ISO-standard card readers. In these cases the RS-RFID would be ignored and tamper evidence would not be provided.

Random numbers are needed for object encryption and other operations. In the absence of hardware random number generation, the system resorts to a software pseudo-random number generator. A feature provided with the SuperCard™ is hardware random number generation capability. Using the hardware source provides much better random number generation and contributes to the strength of the overall security of the system.

### Biometric Data

The process of using a biometric device can generally be described as follows: Initially, a biometric reading taken from the device is digitized; the digital representation is mathematically transformed, and then is stored somewhere as a template. Subsequent biometric readings are compared to this template for verification. Biometric readings can also be used for identification by comparing a biometric reading to templates stored in a database. A match from this database establishes identification. The present invention uses biometrics only for verification during session establishment.

In general, biometric readings will vary by a small amount. A variance from the template value is allowed and is set according to the application and security requirements. This variance is an adjustable factor calculated from the false-success and the false-rejection rates.

Most biometrics can only give a “yes or no” answer to the template comparison. If higher false-success rates can be tolerated, mathematical techniques applied to some types of biometric readings can be used to transform the reading into a repeatable number that can be matched exactly to a stored template. With a repeatable number, biometric data can be provide the system with information used to derive keys used in symmetric and asymmetric key cryptosystems.

It is desirable not to store a biometric reading, including the biometric template, even if it is encrypted. If a repeatable number can result from biometric readings, these biometric values can be used as a piece of data to build the key to unlock user credentials. They can also be used as the basis for the private key in asymmetric key systems used for message authentication.

During user verification, on decryption of the credentials file using a biometric value, the user ID field in the decrypted credentials file is compared to the ID typed by the user. If the comparison is favorable, the user has been authenticated and the data in the credentials file has been decrypted correctly. Biometric data as part of the key used in encrypting a user's credentials file ties that user to the credentials.

Since other pieces of information, such as a password, user 11D, and other data, such as a random number, are used to create credentials encryption key, higher false-success rates from the biometric can be tolerated. Even if two people generate the same biometric value, the credentials encryption key would not be the same for the two since their user IDs and passwords, as well as ephemeral data, are not the same.

A user's private key for digital signatures can be based on the user's repeatable biometric template. A user's public key is generated from the private key. The public key is recorded in the user's Credential Manager's user database as part of the enrollment process. Requiring the user to be present for enrollment establishes identity but other acceptable methods establishing identity can be used.

When repeatable biometrics readings are used, a user's private key, although not stored, is recoverable if lost. In this case a biometric reading would establish the private key and generation of the corresponding public key may be checked against that stored in the Credential Manager's database.

If a repeatable number cannot always be guaranteed from a biometric reading, then a biometric template must be stored for comparison with subsequent biometric readings. In this case the biometric template would be encrypted within a user's credentials file. During user authentication, the credentials file would be decrypted, recovering the biometric template, and then the biometric reading taken for authentication would be compared to the template and a “yes or no” answer would result.

### Message Authentication

Asymmetric key cryptographic systems are used in the system for the three message authentication related objectives stated above. If only data integrity is desired, message authentication codes can be used. If data integrity coupled with secrecy is required, message manipulation codes with asymmetric key encryption can be used. To meet all three message authentication objectives, while providing secrecy, digital signatures are used.

### Digital Signatures

Digital signatures are used to provide data origin authentication, data integrity, and non-repudiation. The infrastructure provided by the system supports a form of a Public-Key Infrastructure (PKI) that distributes signed certificates and public keys used in digital signature verification. In other proposed public-key systems, the certificate authority takes the form of a database on a server that uses query via a network. In the system of the present invention, Credential Managers act as certificate authorities. All information for verifying digital signatures is provided in each user's credentials and in the encrypted objects. Additional bandwidth due to network and server processing is not required as it is in other public-key systems.

The certificate for a user is signed by that user's Credential Manager. Each Credential Manager has its own public and private key. The public keys of the organization's Credential Managers are provided in each user's credentials. The Credential Manager encrypts, that is, signs, a user's ID and public key combination with the Credential Manager's private key. This is a basic user certificate. It can be decrypted only by using the Credential Manager's public key.

A user's certificate is contained in that user's credentials so that it can be sent with objects the user has signed. The recipient of a signed object uses the Credential Manager's public key to decrypt the sender's certificate and recover that user's public key. The recovered sender's public key is then used to verify the sender's digital signatures on the signed object.

A user's biometric template, when available, can form the basis of a user's private key. For example, in the El Gamal Signature Scheme, a public key is the combination of a prime number, p, a primitive element, α, and a value, β, computed from a private number α. This private number is usually picked at random. However, in the present invention, the user's biometric template could become this private number, or part of this number. Because of this, private and public keys used for authentication are tied to an individual. The public/private keys can be recovered (negating the need for storage) if a repeatable biometric value can be obtained.

### Manipulation Detection Codes (MDCs)

If privacy and data integrity without regard to data origin authentication and non-repudiation are desired, an MDC combined with encryption can be used. An MDC is basically an “unkeyed” hash function that is computed from the message. This hash is then appended to the message, and the new message is encrypted.

From verification of data integrity, a recipient decrypts the message, separates the hash from the message, computes the MDC of the recovered message, and compares this to the decrypted hash. The message is accepted as authentic if the values match.

### Message Authentication Codes (MACs)

If only data integrity without regard to privacy is needed, a MAC can be used. The working key for the MAC is constructed in the same way as that for the key used for encrypting a message for privacy, that is, by using the combiner process with label splits, organization split, maintenance split and a random split.

To verify data integrity, the recipient of the MACed message uses the splits associated with the message to rebuild the key for the MAC. A new MAC is then calculated by the recipient and compared to the MAC sent with the message. If the two MACs match, the message is accepted as not having been altered.

It is not expected that MDCs and MACs will be used as often as digital signatures. Therefore, MDCs and MACs will not be mentioned in the process descriptions that follow.

### The Process

Selected processes are described to illustrate how the present invention accomplishes its tasks. It is assumed that a smart card such as the SuperCard™ and biometrics with the ability to generate a constant biometric value are used.

### Session Establishment (Logging On to the System)

Use of the system is contingent on successful logon and decryption of user credentials. Session establishment begins when a system-enabled program is run on a user's workstation. The workstation prompts the user to present the smart card, user biometrics, user ID, and password (logon data). An encrypted channel is established between the workstation and smart card and the logon data is transferred to the smart card where a key is generated to decrypt the user's credentials. The credentials ca n reside on the smart card or in some other location, in which case the encrypted credentials file would be sent to the smart card for decryption and u se. On successful logon, the credentials file is re-encrypted and stored and a decrypted copy is kept in the smart card's memory for use during the session.

Note that three things are needed to complete logon—a password, a smart card (or other token), and biometric information. Without knowing the password, an adversary needs to guess or search the entire password space. Random bits are used as a start for the credential decryption process so that if password guessing is used the output could not so easily be detected by the adversary as correct. Changing these random bits continually prevents an adversary from bypassing the process by “replaying” past results. Password policies, such as minimum characters required in a password, increase security when passwords alone are used for user authentication. Passwords alone are still considered weak authentication. Smart cards and biometrics are recommended for strong authentication.

The smart card must be present to complete logon. Putting random bits for the credentials file key generation on the smart card cryptographically ties that card to the user's credentials and hence to the user. The smart card alone will not complete the logon without a user's password. The password is not stored on the smart card, and so loss of the card to an adversary does not compromise a user's password or the user's credentials.

When the SuperCard™ is used, the inherent radio frequency signature detects tampering with the card by comparing this signature to the one stored in the user's credentials. The SuperCard™ can still be used in a standard ISO smart card reader but the RS-RFID would be ignored.

Using biometric data as a piece of information to build the key to decrypt the user's credentials cryptographically ties the biometric data, and hence the user, to the credentials file. Thus, knowledge of the user's password and possession of the user's smart card will not be enough information to decrypt the user's credentials. Compromise of the password and smart card does not disclose a user's biometric data, as it is not stored on the card, or anywhere for that matter, even in an encrypted form.

Once logged on, a user will remain logged on as long as a program is actively being used and while the smart card remains in the card reader. There is a time-out value, set by the Credential Manager, beyond which if the user does not actively use an enabled program, the session is disabled. The user must then present the password and biometrics again to continue using enabled software. When a user quits an enabled program and there are no other enabled programs running at that time, the user may log off or continue to stay logged on until the time-out period has lapsed. Within this time-out period, if another enabled program is invoked, the user does not have to log on. If, however, the time-out period has lapsed, the user will have to log on again. During this period when no enabled program is running, and before the time-out value has expired, the user may run a utility program that will quickly log that user off.

Encryption with Digital Signature

Encryption of objects requires the choice of a cryptographic algorithm and label splits. This choice will determine who will be able to decrypt the object. Default label and algorithm selection is provided for convenience. This streamlines the encryption process, especially when the majority of data is encrypted using the same label set and algorithm. The Credential Manager may set this default. It can be made most restrictive, in which case a user need change the label selection only to make the label set less restrictive. The splits corresponding to the user-selected and mandatory use labels are used by the combiner process to generate a key that is used to initialize the user-selected cryptographic algorithm.

A cryptographic hash is applied to the object's plaintext, that is, before the data is encrypted. The hash value is then encrypted with the user's private key (which has been generated based on the user's biometric reading), resulting in the digital signature for that object.

Digital signatures may be an option or may be mandatory depending on Policy Manager requirements.

A header is created containing the user's label and algorithm choice, the user's certificate, a digital signature and other information that might be required for decrypting the object. This header is appended to the encrypted object.

Decryption with Digital Signature Verification

Decryption starts by decrypting and reading the header of an encrypted object. If the user has read permission for the labels used in encryption and has access to the algorithm used, then the object may be decrypted.

For signature verification the object must first be decrypted so that a cryptographic hash can be computed. This means that only those who have read permission for the labels used for encryption will be able to verify the digital signature. Once the hash is computed, the public key of the encryptor's Credential Manager is retrieved from the credentials. This public key is used to decrypt the certificate contained in the header, thus recovering the signatory's public key. The verification module takes the encryptor's public key, the digital signature, and the hash value that was computed from the decrypted data as input. If the verification module returns a “Yes” answer, then the object is declared as being authentic.

### Detection

The intent of detection is to notify certain individuals and to take certain actions whenever events indicative of intrusion, tampering or failure have taken place. At its simplest, detection is provided with audit of selected events. The minimum events to be audited are determined by the Policy Manager.

Detection can take other forms, such as statistical tests for randomness on generated random numbers. Weak cryptographic key detection can also be performed. These types of alarms would notify or stop a user from continuing with an action that might compromise the security of the system.

An example of another technique is use of monitors that can read headers periodically, or at random, and verify the label sets contained therein against a user's issued labels per the Credential Manager's database. This would aid a security administrator to detect when someone might be trying to gain unauthorized access.

There are many techniques, some of them hardware-based, that can be used for event detection and ala rm. Use of these will be controlled by the Policy Manager and the Credential Managers.

### SUMMARY

The present invention technology can provide an effective system for encrypting data-at-rest. It can also provide a suitable system for encrypting data-in-transit. The present invention can be extended beyond the application protocol level to lower levels, such as level 2 (for example IEEE 802) in the OSI stack. The encryption protocol to establish the session key for the channel can be adapted to the parameters of the communications environment.

An application programming interface implementing the present invention can be used to develop secure applications. Software can be used to provide file and e-mail encryption, incorporating selected elements of the technology described herein. The present invention can also be used to add encryption to audio and graphics applications.

### Label Set Design

The present invention uses encryption to provide selective access to information. When encrypting with the present invention, users (persons or devices), manually or automatically, select labels they share with intended receivers of the information being encrypted. The user may apply as many labels as needed to target a specific subset of information or information grouping. Only users holding credentials containing matching labels will be able to view the information.

Labels are the humanly understandable counterparts of the cryptographic splits. They form the variable part of a symmetric access control system. The selection and deployment of labels are extremely important in creating a useful cryptosystem.

The present invention is well suited for data separation and role-based access to information. Data separation is the process of assigning information to levels or categories and then restricting access to each based on need-to-know or other security policy. Role-based access is the method that assigns access to information by roles performed and then assigns individuals to these roles. Each individual's access to information changes as her roles change. The Internet has facilitated the creation of search engines that access information in many databases. The tagging or indexing methodology of these search engines can be correlated to labels that are included in the cryptosystem.

All information within any organization does not have the same disclosure risk. The disclosure of some information could have a serious negative impact depending on circumstances. A time-honored method to minimize unauthorized disclosures is to keep information within organizational compartments and to establish policies, procedures, and controls appropriate for each.

Labels can mirror established information compartments within an organization. For example, if a large organization has identified 500 information compartments then the Policy Manager would create 500 labels representing these compartments. Specific labels would be assigned to individuals assigned to roles with access to specific compartments. Top-down mandated information compartments simplify the process for individual users. If an individual is assigned to roles within two information compartments, then his credentials only present these two label options for encryption. In practice, however, a total mandated compartment system is not sufficiently flexible. It is best to allow each user some flexibility in designating readership restrictions for material to be sent outside mandated compartments.

Labels also can be used to designate readership across the organization. For example, the label “Personnel Information” may be issued to all persons within the organization. All persons would be able to encrypt information using this label; however, only managers and those persons assigned to the personnel department would be able to decrypt such information. Other “across the organization” labels with similar encrypt and decrypt restrictions might include Security, Legal, Inspector General, or other organizational groups or functions.

The use of templates can aid the distribution of labels. Templates can be made to include labels that represent an organization's information flow boundaries, or to represent a grouping of information subsets. By nesting templates and assigning them to numerous users at the same time, the distribution process is greatly facilitated. For example, a basic role template may be created containing the labels to be assigned to all employees. Additional templates may be created and assigned for supervisors, managers, and executives, or other roles as required.

Care must be taken to design a label set that is as limited as necessary to meet security requirements. The objective should be to combine labels representing a mandated compartment approach with labels that allow for ad hoc and cross-organizational (compartment) communications. The resulting label set will allow a simple, easy to use sub-set to be distributed to each user.

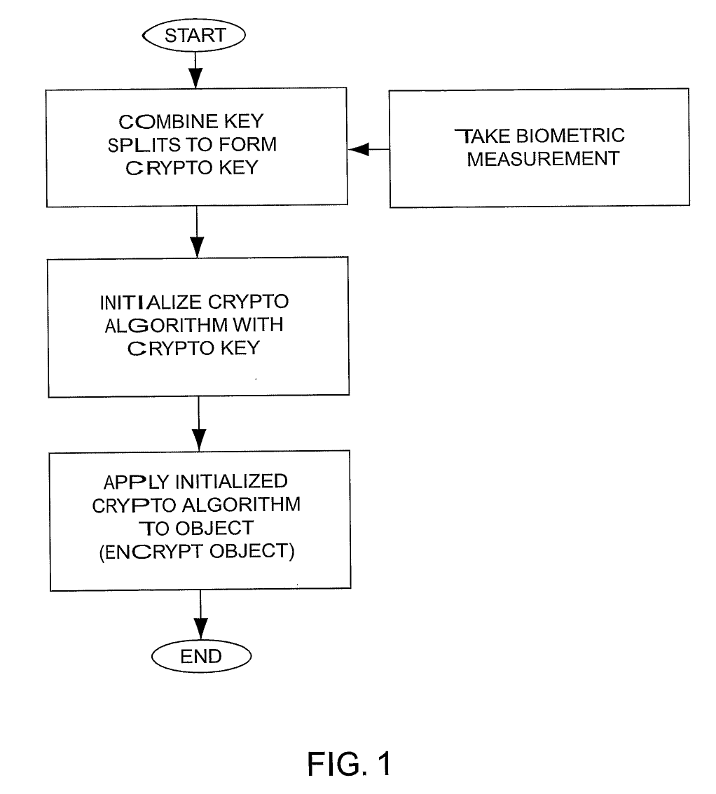

As an example, FIG. 1 shows a process of encrypting an object. As shown, a number of key splits are bound to generate a cryptographic key. A cryptographic algorithm is initialized with the cryptographic key. The initialized cryptographic algorithm is applied to at least a portion of the object according to at least one cryptographic scheme, to form an encrypted object. At least one of the number of key splits corresponds at least in part to a biometric measurement.

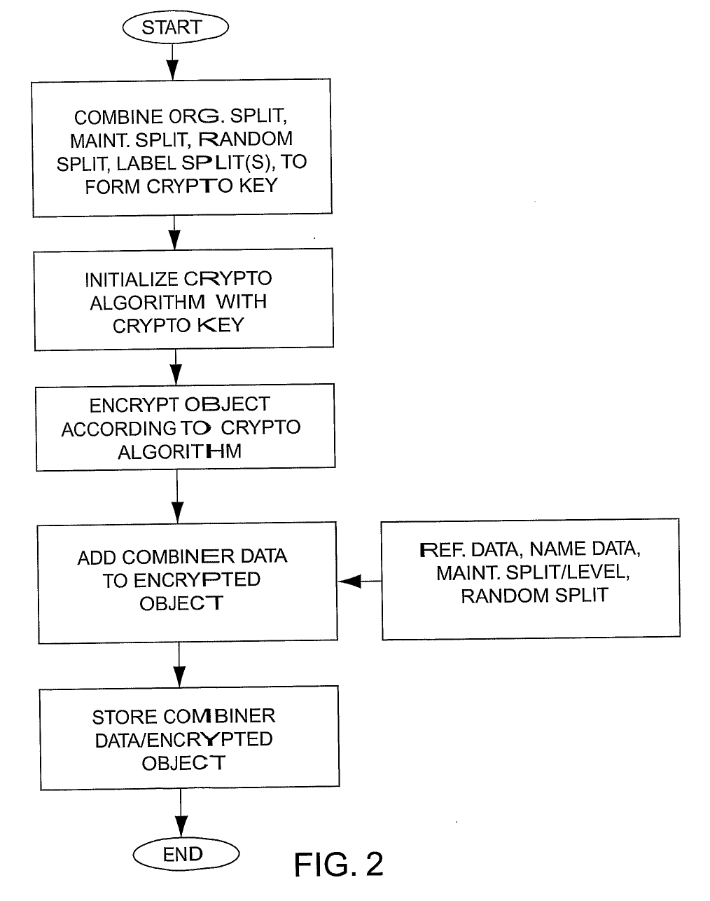

FIG. 2 shows another exemplary process according to the present invention. As shown, a process of encrypting an object includes generating a cryptographic key by binding an organization split corresponding to the organization, a maintenance split, a random split, and at least one label split. A cryptographic algorithm is initialized with the cryptographic key. At least a portion of the object is encrypted according to the initialized cryptographic algorithm, to form an encrypted object. Combiner data is added to the encrypted object. The combiner data includes reference data corresponding to at least one of the at least one label split and the cryptographic algorithm, name data associated with the organization, at least one of the maintenance split and a maintenance level associated with the maintenance split, and the random split. The encrypted object can be stored with the added combiner data for subsequent use by an intended recipient.

### Secure Operational Control

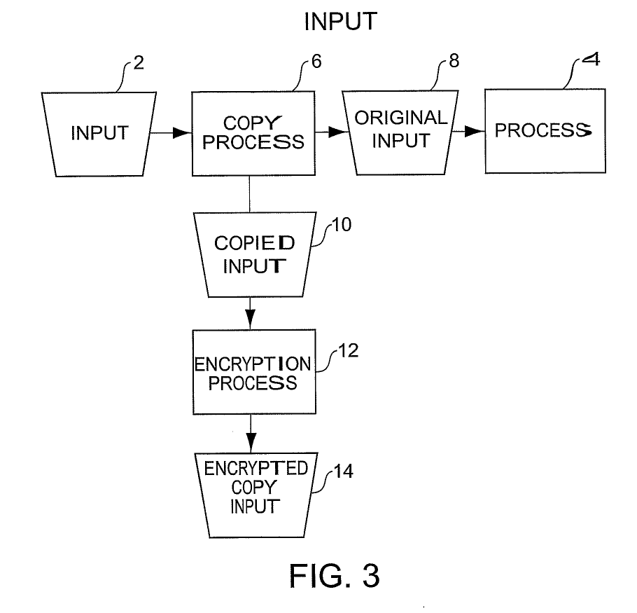

FIG. 3 is a flow diagram of a system using encryption as a tool for checking the integrity of a process. An input 2 is provided to a system, which is intended to be manipulated by a process 4. However, this input 2 first undergoes a copy process 6 to provide identical inputs 8 and 10. The input 8 is passed on to be processed 4, while the input 10 is encrypted by an encryption process 12. The result of the encryption process 12 is an encrypted copy input 14. An authorized recipient will consider this encrypted copy input 14 to be reliable, due to the integrity provided by the encryption process 12.

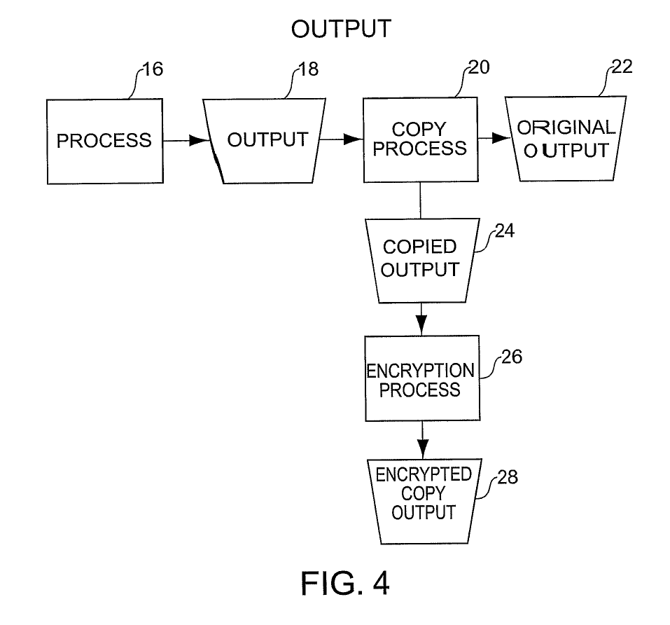

Similarly, FIG. 4 shows encryption used in an output context. A process 16 of the system produces an output 18. This output undergoes a copy process 20 to produce two identical outputs 22 and 24. The output 22 continues to its normal destination as determined by the functionality of the system. The output 24 is provided to an encryption process 26, which manipulates the output 24 to generate an encrypted copy output 28. An authorized recipient will consider this encrypted copy output 28 to be reliable, due to the integrity provided by the encryption process 26.

Processes in this context are the manipulation of data according to a set of defined procedures in order to produce a desired result. The result of a process can be used as an input to another process, either within or outside the sub-system, or may be for use outside of the electronic system, is such as for display on a screen or other presentation device for direct human use.

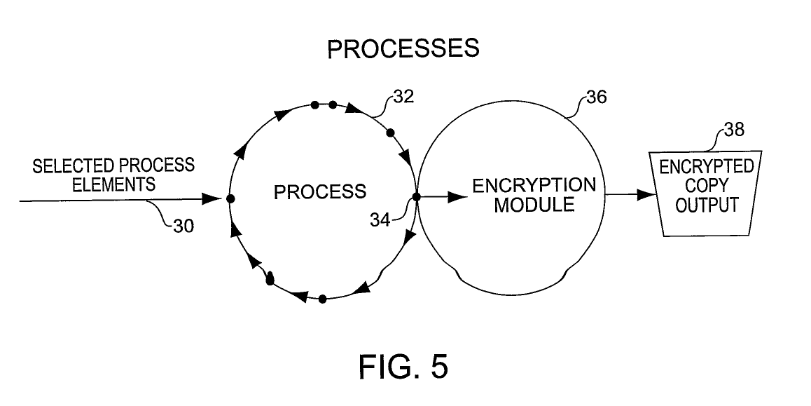

For example, FIG. 5 shows a process 32 by which selected process elements 30, provided as inputs to the process 32, are manipulated. At a predetermined point 34 in the process 32, the process 32 may be sampled and encrypted by the encryption module 36 to provide an encrypted output 38. Thus, an authorized recipient examining a decrypted version of the encrypted output 38 would have a high level of confidence in the reliability of the process sample due to the integrity provided by the encryption module 36.

Scheduled conditions in this context are the status of all or designated processes, registers, and other conditions within a system at specific times. A review of chronological records of this status information provides evidence of how the system functioned during a specific time period.

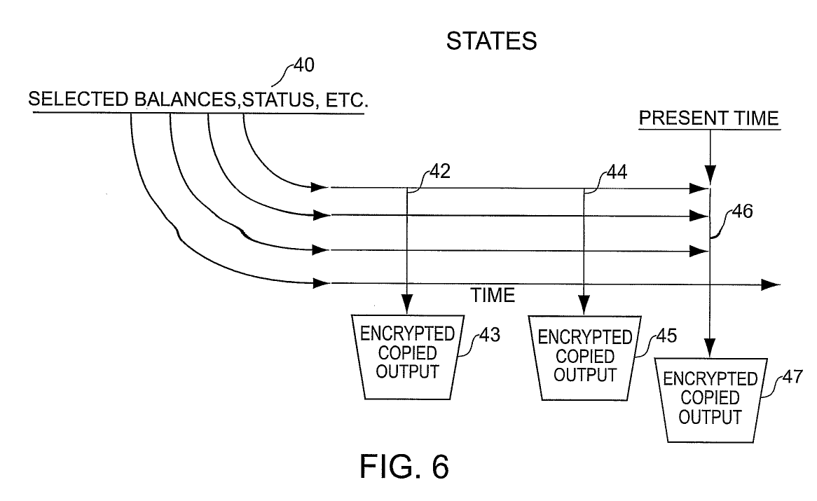

For example, FIG. 6 shows how scheduled conditions can be sampled in a system, so that they can be encrypted to provide a secure, reliable “snapshot” of the system at particular points in time. As the system operates, selected balances, status, and other processes are sampled at different points in time 42, 44, 46. As shown, at a first point in time 42, the processes 40 were sampled to provide a reading of the scheduled condition of the system at that point in time 42. This scheduled condition sample was then encrypted to provide a characteristic encrypted output 43 at the first selected point in time 42. Likewise, at a second point in time 44, the processes 40 were sampled to provide a reading of the scheduled condition of the system at that point in time 44. This scheduled condition sample was then encrypted to provide a second characteristic encrypted output 46 at the second selected point in time 44. Finally, at the present time 46, the processes 40 are sampled to provide a reading of the present scheduled condition of the system. This scheduled condition sample is then encrypted to provide a characteristic encrypted output 47 of the present scheduled condition of the system. Future samples can be taken and encrypted outputs generated. Thus, an authorized recipient examining a decrypted version of the encrypted outputs 43, 45, 47 would have a high level of confidence in the reliability of the scheduled condition samples due to the integrity provided by the encryption process.

Virtual environments in this context are the conditions and influences that were present in the system at the time of encryption. By including virtual environmental information in the scope of encryption, the nature and effect of all influences on encrypted objects can be recorded and analyzed. Virtual environmental information would include, but not be limited to, such things as the order of processing as compared to similar or other items; preprocessing of data, such as data conversion and reformatting; status of other active processes or threads; operating system control information; identity of users logged on; network monitoring information; and other active control processes.

By bonding virtual environmental information to selected data objects with encryption, not only is the integrity of the data object assured, but also the nature and extent of the environment that produced the object can be verified. Further, encrypted objects can be embedded within other objects, encrypted or otherwise, to provide an access hierarchy for users of a system, as described in U.S. Pat. No. 5,369,702 to Shanton. Encrypted objects within the context of the present invention provide verification of the electronic control hierarchy for management and other parties.

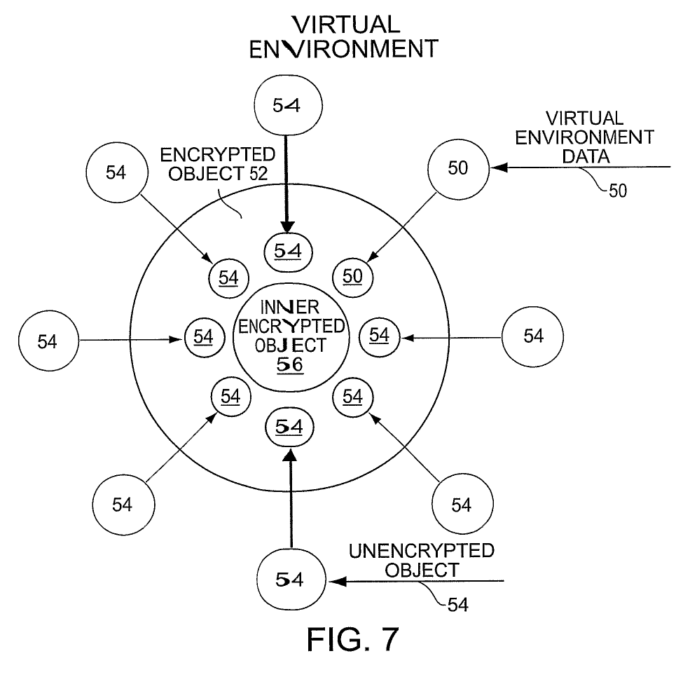

FIG. 7 shows how virtual environmental data 50 can be collected and embedded within an encrypted object 52. Other related unencrypted objects 54 can also be embedded within the same encrypted object 52, as another encrypted object 56 can be. Of course, the collected virtual environment data 50 can be encrypted prior to being embedded within the encrypted object 52, and the inner encrypted object 56 can contain other encrypted and/or unencrypted objects. An authorized recipient examining an extracted virtual environment data object would have a high level of confidence in the reliability of the corresponding data due to the integrity provided by the encryption process used to create the container for the object.

Management, taxing jurisdictions, regulatory authorities, internal authorized recipients, independent accountants, and other parties can use these features to monitor and audit control systems, as well as the interaction of control systems—a significant benefit as business moves to an electronic world. With this technology, control systems that allow for substantive procedures can provide evidence that other control systems are operating as designed.

Thus, the system can be viewed as an encryption process used to protect and control related objects, or it can be viewed as an audit and control tool to ensure the integrity of the process. A process, such as XML, extends management flow control ability over objects within or retrieved from databases.

The invention will now be described in terms of a particular process, that is, the Extensible Markup Language (XML), for ease of explanation. It is important to note, however, that the invention is not limited to use of this exemplary process, and is intended to be used as broadly as described elsewhere herein. XML is a method that is used to structure and describe data so that it can be understood by different software applications, including database and electronic commerce applications. XML uses tags to label data objects as to meaning, preferably using a specific common industry-wide convention, so that software applications with different purposes and created by different vendors can pass data objects between and among them without the need to restructure the data. XML allows applications to use tagged data objects for input. XML can be used for information that is transferred from one application to another. Applications include, but are not limited to, business transactions, financial statements, purchase orders, product catalogs, medical histories, database retrieval, etc.

In this example, XML tags are used by application, and perhaps operating system, software to identify accounting and operational control system objects. Secure accounting and operational control and reporting system (SAOCRS) application software examines selected tagged data objects and, if appropriate, encrypts a copy of the tagged object or groups of is objects. Further, encrypted objects can be embedded within other objects, encrypted or otherwise, to provide an access hierarchy for users of a system, as described in U.S. Pat. No. 5,369,702 to Shanton. XML labels can be directly related to or may be grouped or converted in order to relate to referenced process. The encrypted objects are then either passed directly on a real-time basis to authorized recipients for immediate decryption and further processing, or they are stored and forwarded at a later time.

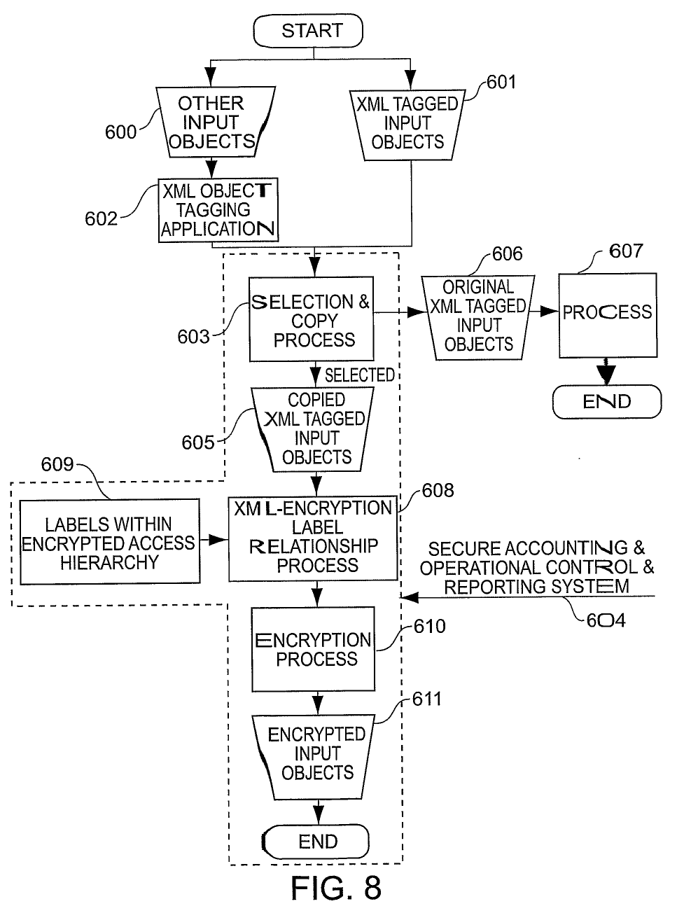

FIG. 8 is a flow diagram showing use of XML to identify, copy, and encrypt input objects in a SAOCRS. Initially, input objects 600 might or might not be related to XML tags; if so, the XML-tagged input objects 601 are provided directly to the selection and copy process 603. If required, an XML object-tagging application 602 applies appropriate XML tags to the input objects 600. The SAOCRS 604, using XML tags to identify object attributes, selects certain objects 605 according to control requirements and causes identical copies to be made. Original tagged input objects 606 are allowed to pass to their intended processes 607.

Within the SAOCRS 604, the XML tags of each copy of selected input objects 605 are related 608 to labels within the encrypted access hierarchy 609 to determine the appropriate role-based access label or labels to be used to encrypt each object. Role-based labels are descriptors of a type or category of access, rather than the identity of a particular person or device allowed access. Each input object copy is encrypted 610 and passed to or stored 611 for appropriate persons, devices, or other systems, including other SAOCRSs.

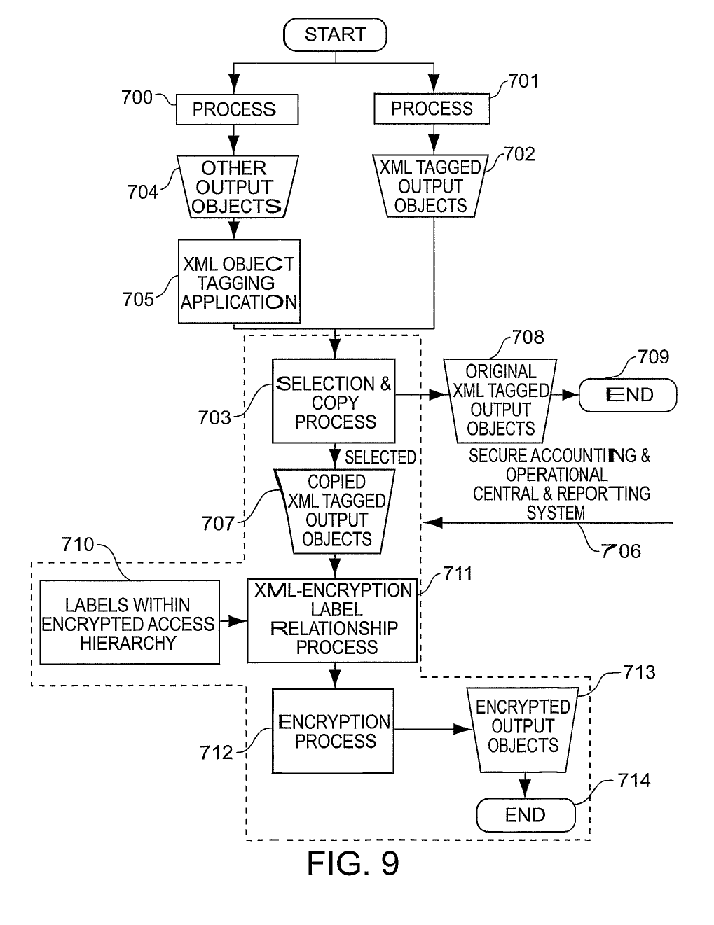

FIG. 9 is a flow diagram showing use of XML to identify, copy, and encrypt copied output objects in a SAOCRS. Initially, output objects 704 of a process 700, 701 might or might not be related to XML tags; if so, the XML-tagged output objects 702 are provided directly to the selection and copy process 703. If required, an XML object-tagging application 705 applies appropriate XML tags to output objects 704. The SAOCRS 706, using XML tags to identify object attributes, selects certain objects 707 according to control requirements and causes identical copies to be made. Original tagged output objects 708 are allowed to pass to their intended processes 709.

Within the SAOCRS 706, the XML tags of each copy of selected output objects 707 are related 711 to labels within the encrypted access hierarchy 710 to determine the appropriate role-based label or labels to be used to encrypt 712 each object. Each output object copy is encrypted 713 and passed to or stored 714 for appropriate persons, devices, or other systems, including other SAOCRSs.

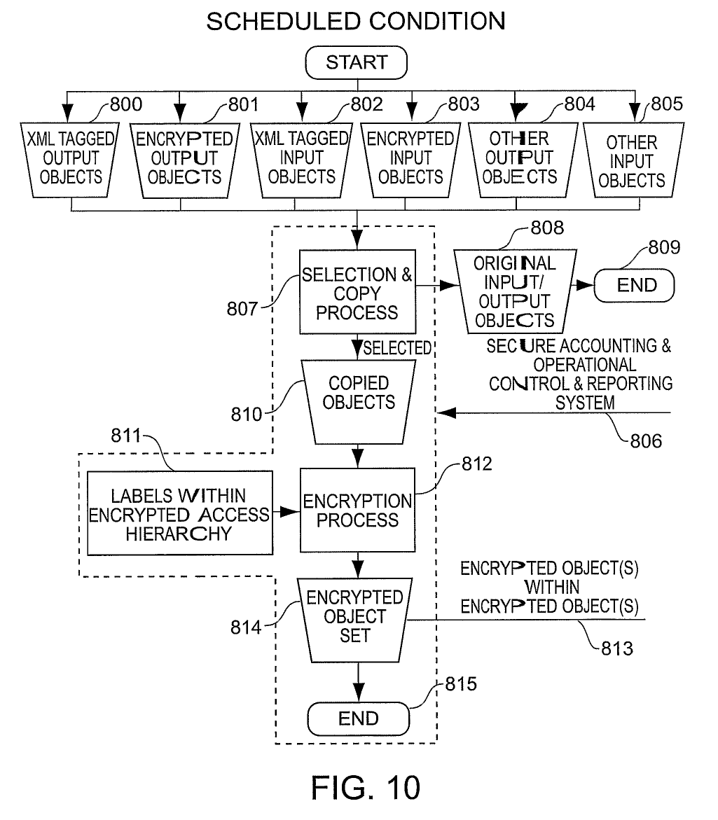

FIG. 10 is a flow diagram showing use of XML to identify, copy, and encrypt copied objects in a SAOCRS that in their entirety present a scheduled condition check. The SAOCRS, from time to time as required, selects input and output objects 800-805 that, when considered in their entirety, fairly represent the condition of a system and in turn assist in affirming the veracity of objects that form the basis for operational or audit activity. Selected objects 800-805 might or might not have related XML tags that assist in object selection. They each can be either an input or an output is of one of multiple separate processes. They can be encrypted input and output objects from other SAOCRSs.

The SAOCRS 806, where possible using XML tags to identify objects attributes, selects certain objects according to control requirements and causes identical copies to be made 807. Original objects 808 are allowed to pass to their intended processes 809.

Within the SAOCRS 806, the XML tags of each copy 810 of a selected object are related to labels 811 within the encrypted access hierarchy to determine the appropriate role-based label or labels to be used to encrypt 812 each object 810. Each selected object 810 without XML tags is related to labels 811 within the encrypted access hierarchy to determine the appropriate role-based label or labels to be used to encrypt 812 each object. Based on the labels 811 used to encrypt 812 each set of objects 810, the SAOCRS 806 determines the appropriate label or labels 811 to be used to encrypt 814 all objects within one overall object 813. This inclusive encrypted object 814, containing encrypted objects verifying the system condition, is then passed to or stored 815 for appropriate persons, devices, or other systems, including other SAOCRSs.

Thus, a system for providing an encryption process and for providing secure accounting and operational control is described. Such a process can be applied advantageously to a process or scheme utilizing an XML form at or any other scheme utilizing tagged data elements. Further, any encryption process can be used, and a particularly advantageous encryption process and system is described for use in providing secure operational control as is described.

We claim:

1. A process of encrypting an object that is consistent with a data format and has an object tag associated therewith, comprising:
binding a plurality of key splits to generate a cryptographic key;
initializing a cryptographic algorithm with the cryptographic key; and
applying the initialized cryptographic algorithm to at least a portion of the object according to at least one cryptographic scheme determined at least in part by the object tag, to form an encrypted object;
wherein at least one of the plurality of key splits corresponds at least in part to a biometric measurement.

2. The process of claim 1, further comprising storing the encrypted object for subsequent use by an intended recipient.

3. The process of claim 1, further comprising selecting the object from a plurality of objects, at least in part according to the associated object tag.

4. The process of claim 1, wherein the object is an Extensible Markup Language element.

5. The process of claim 1, further comprising adding at least one key split of the plurality of key splits to the encrypted object.

6. The process of claim 1, further comprising adding reference data associated with at least one key split of the plurality of key splits to the encrypted object.

7. The process of claim 1, further comprising retrieving at least one key split of the plurality of key splits from a storage medium.

8. The process of claim 7, wherein the storage medium is disposed on a smart card.

9. The process of claim 1, wherein binding a plurality of key splits to generate a cryptographic key is performed on a smart card.

10. In a cryptographic system associated with an organization, a process of encrypting an object that is consistent with a data format and has an object tag associated therewith, comprising:
generating a cryptographic key by binding an organization split corresponding to the organization, a maintenance split, a random split, and at least one label split;
initializing a cryptographic algorithm with the cryptographic key;
encrypting at least a portion of the object according to the initialized cryptographic algorithm determined at least in part by the object tag, to form an encrypted object; and
adding combiner data to the encrypted object;
wherein the combiner data includes
reference data corresponding to at least one of the at least one label split and the cryptographic algorithm,
name data associated with the organization,
at least one of the maintenance split and a maintenance level associated with the maintenance split, and
the random split.

11. The process of claim 10, further comprising storing the encrypted object with the added combiner data for subsequent use by an intended recipient.

12. The process of claim 10, further comprising selecting the object from a plurality of objects, at least in part according to the associated object tag.

13. The process of claim 10, wherein the object is an Extensible Markup Language element.

14. The process of claim 10, further comprising selecting the at least one label split from at least one credential.

15. The process of claim 14, wherein the selected at least one label split is encrypted, the cryptographic key is a first cryptographic key, and the process further comprises:
deriving a second cryptographic key from a user ID associated with a user, a password associated with the user, and at least one of a unique data instance and a random value, and
decrypting the selected at least one label split using the second cryptographic key.

16. The process of claim 14, wherein the at least one credential is retrieved from a memory.

17. The process of claim 16, wherein the memory is disposed on a smart card.

18. The process of claim 14, further comprising generating a time stamp corresponding to a time at which the object was encrypted, wherein the combiner data further includes the time stamp.

19. The process of claim 14, wherein the combiner data further includes a user ID associated with a user.

20. The process of claim 10, further comprising generating a time stamp representing a time at which the object was encrypted, wherein the combiner data further includes the time stamp.

21. The process of claim 10, wherein the combiner data is a header record.

22. The process of claim 10, wherein the combiner data further includes one of a digital signature and a digital certificate.

23. The process of claim 10, wherein the combiner data further includes a digital signature and a digital certificate.

24. The process of claim 10, wherein the cryptographic key is a first cryptographic key, the process further comprising:
generating a second cryptographic key based at least in part on the at least one label split; and
encrypting the random split using the second cryptographic key, prior to adding the combiner data to the encrypted object;
wherein the random split included in the combiner data is the encrypted random split.

25. The process of claim 10, further comprising encrypting at least a portion of the combiner data using a header split before adding the combiner data to the encrypted object.

26. The process of claim 25, wherein the header split is constant.

27. A storage medium comprising instructions for causing a data processor to encrypt an object that is consistent with a data format and has an object tag associated therewith, wherein the instructions include:
generate a cryptographic key by binding a plurality of key splits;
initialize a cryptographic algorithm with the cryptographic key; and
apply the initialized cryptographic algorithm to at least a portion of the object according to at least one cryptographic scheme determined at least in part by the object tag, to form an encrypted object;
wherein at least one of the plurality of key splits corresponds at least in part to a biometric measurement.

28. The storage medium of claim 27 wherein the instructions further include:
select the object from a plurality of objects, at least in part according to the associated object tag.

29. The storage medium of claim 27, wherein the object is an Extensible Markup Language element.

30. The storage medium of claim 27, wherein the instructions further include:
add at least one key split of the plurality of key splits to the encrypted object.

31. The storage medium of claim 27, wherein the instructions further include:
add reference data associated with at least one key split of the plurality of key splits to the encrypted object.

32. The storage medium of claim 27, wherein the instructions further include:
retrieve at least one key split of the plurality of key splits from a memory.

33. The storage medium of claim 32, wherein at least a portion of the memory is disposed on a smart card.

34. The storage medium of claim 27, wherein the data processor is distributed, and the instruction to generate a cryptographic key is executed at least in part on a smart card.

35. A storage medium comprising instructions for causing a data processor to encrypt an object that is consistent with a data format and has an object tag associated therewith, wherein the instructions include:
generate a cryptographic key by combining an organization split corresponding to an organization, a maintenance split, a random split, and at least one label split;
initialize a cryptographic algorithm using the cryptographic key;
apply the initialized cryptographic algorithm to at least a portion of the object according to the initialized cryptographic algorithm determined at least in part by the object tag, to form an encrypted object;
add combiner data to the encrypted object, wherein the combiner data includes
reference data corresponding to at least one of the at least one label split and the cryptographic algorithm,
name data associated with the organization,
at least one of the maintenance split and a maintenance level corresponding to the maintenance split, and
the random split; and
store the encrypted object with the combiner data for subsequent access.

36. The storage medium of claim 35, wherein the instructions further include:
select the object from a plurality of objects, at least in part according to the associated object tag.

37. The storage medium of claim 35, wherein the object is an Extensible Markup Language element.

38. The storage medium of claim 35, wherein the instructions further include:
select the at least one label split from at least one credential.

39. The storage medium of claim 38, wherein the selected at least one label split is encrypted, the cryptographic key is a first cryptographic key, and the instructions further include:
derive a second cryptographic key from a user ID associated with a user, a password associated with the user, and at least one of a unique data instance and a random value; and
decrypt the selected at least one label split using the second cryptographic key.

40. The storage medium of claim 38, wherein the instructions further include:
retrieve at least one credential from a memory.

41. The storage medium of claim 40, wherein the memory is disposed on a smart card.

42. The storage medium of claim 38, wherein the instructions further include generate a time stamp corresponding to a time at which the object was encrypted, wherein the combiner data further includes the time stamp.

43. The storage medium of claim 38, wherein the combiner data further includes a user ID associated with the user.

44. The storage medium of claim 35, wherein the instructions further include:
generate a time stamp corresponding to a time at which the object was encrypted, wherein the combiner data further includes the time stamp.

45. The storage medium of claim 35, wherein the combiner data is a header record.

46. The storage medium of claim 35, wherein the combiner data further includes one of a digital signature and a digital certificate.

47. The storage medium of claim 35, wherein the combiner data further includes a digital signature and a digital certificate.

48. The storage medium of claim 35, wherein the cryptographic key is a first cryptographic key, and the instructions further include:
generate a second cryptographic key based at least in part on the at least one label split; and
encrypt the random split using the second cryptographic key, prior to executing the instruction to add the combiner data to the encrypted object;
wherein the random split included in the combiner data is the encrypted random split.

49. The storage medium of claim 35, wherein the instructions further include:
encrypt at least a portion of the combiner data using a header split prior to executing the instruction to add the combiner data to the encrypted object.

50. The storage medium of claim 49, wherein the header split is constant.
